(19) United States
(12) Patent Application Publication
(10) Pub. No.: US 2007/0262850 A1
(43) Pub. Date: Nov. 15, 2007

(54) Electronic Security Seal

(75) Inventor: Mikael Willgert, Spanga (SE)

Correspondence Address: ALFRED J MANGELS, 4729 CORNELL ROAD, CINCINNATI, OH, 452412433, US

(73) Assignee: Tagmaster AB, Kista (SE)

(21) Appl. No.: 11/631,760

(22) PCT Filed: Jun. 14, 2005
(86) PCT No.: PCT/SE05/00900

§ 371 Date: May 31, 2007

(30) Foreign Application Priority Data
Jul. 6, 2004 (SE) 0401781-0

(51) Int. Cl. H04Q 5/22

(52) U.S. Cl. 340/10.3

(57) ABSTRACT

A seal for sealing goods in goods containers, such as freight containers, freight cars, trucks, and the like. The seal interacts with a door or other hatch that can be opened in order to seal it against unauthorized opening. The seal is activated when the goods container is loaded and is broken when the goods in the goods container are unloaded. The seal includes a transponder that includes a memory and that communicates with a communicator for the reading of information stored in the transponder memory. The seal is placed into an active mode during the sealing operation, and information as to the time when the seal is opened is stored in the transponder memory. The opening time information is subsequently read by the communicator.

### BACKGROUND OF THE INVENTION

1. Field of the Invention

The present invention relates to a seal, and more particularly to a seal of the type used to seal cargo and goods that are stored in a closed container or the like, wherein a door or equivalent is provided with a seal when in a closed position.

2. Description of the Related Art

The function of such a seal is to enable a person to determine whether or not the door has been opened after the seal has been applied. Such seals are often a wire that is intended to be threaded through a hasp, wherein the free ends of the wire are united by means of a lead seal.

One problem associated with such seals, which are often used on goods containers, trucks, and freight cars, is that although it is possible to determine that a seal has been broken, but not to determine when the seal was broken. Furthermore, it may be possible to manipulate the seal such that during a hasty check it appears to be unbroken.

Such seals are thus not particularly useful when it is a matter of tracing, for example, gangs that steal goods from containers, trucks, or freight cars.

It is desired that the security that is to be achieved with the seal should be higher.

The present invention offers a seal that offers significantly increased security.

### SUMMARY OF THE INVENTION

The present invention thus relates to a seal for sealing goods in goods containers, such as freight containers, freight cars, trucks, and the like. The seal is arranged to interact with a door or other hatch that can be opened in order to seal it against unauthorized opening. The seal is intended to be activated when the goods container is loaded, and it is arranged to be broken when the goods in the goods container are to be unloaded. The seal includes a transponder arranged to communicate with a communicator for the reading of information stored in the transponder, wherein the transponder is placed into an active mode during the sealing operation. The transponder stores in a memory associated with the transponder time information as to when the seal is opened. The time information can be read by means of the communicator.

### BRIEF DESCRIPTION OF THE DRAWINGS

The invention is described in more detail below, partially in association with an embodiment of the invention shown in the attached drawings, in which

FIG. 1 shows a block diagram of a known communication unit;

FIG. 2 shows a block diagram of a known automatic identification system;

FIG. 3 shows an embodiment of a seal in accordance with the present invention;

FIG. 4 shows a larger scale drawing of the seal shown in FIG. 3; and

FIG. 5 shows a block diagram of the seal shown in FIGS. 3 and 4.

### DESCRIPTION OF THE PREFERRED EMBODIMENTS

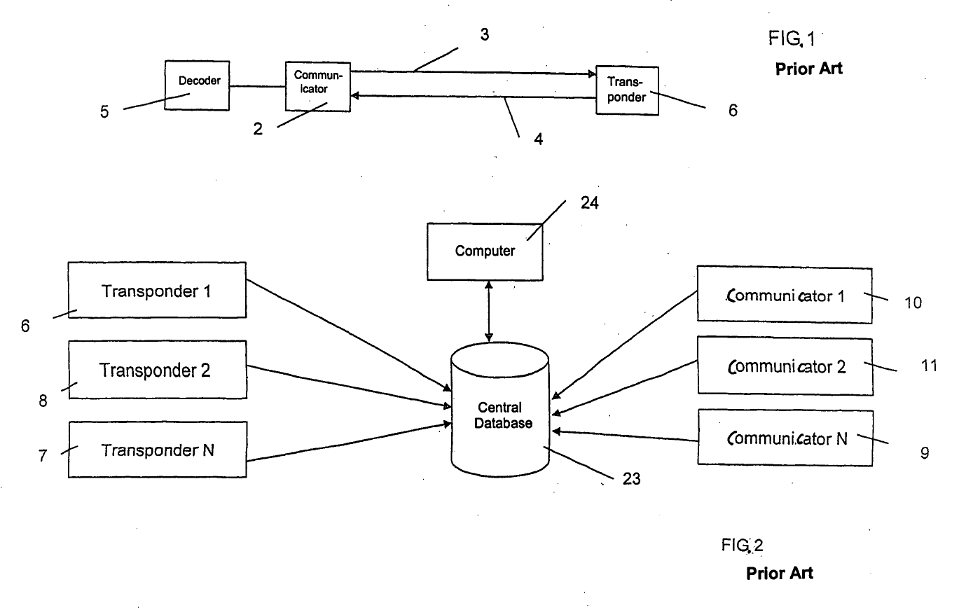

A known communication unit is shown in FIG. 1. The communication unit includes a transponder 6 and a communicator 2 in the form of a receiver/transmitter unit. The communicator 2 is configured to transmit an inquiry signal 3 to the transponder 6. The transponder is configured to receive the inquiry signal and to reflect and modulate the inquiry signal. The communicator 2 is configured to receive the reflected signal 4 and to decode its information content by means of a decoder 5.

Several known automatic identification systems are available that exploit radio frequencies and are known as RFID (Radio Frequency Identification) systems. One such system is shown in FIG. 2. They contain transponders 6, 7, 8 (ID tokens) of the type described above and communicators 9, 10, 11 for the reading of information from the transponders and, where appropriate, writing of information into the transponders. The applicant supplies such identification systems.

The communicators 9, 10, 11 normally constitute in such a system fixed deployed units for radio communication between those units and mobile transponders 6, 7, 8.

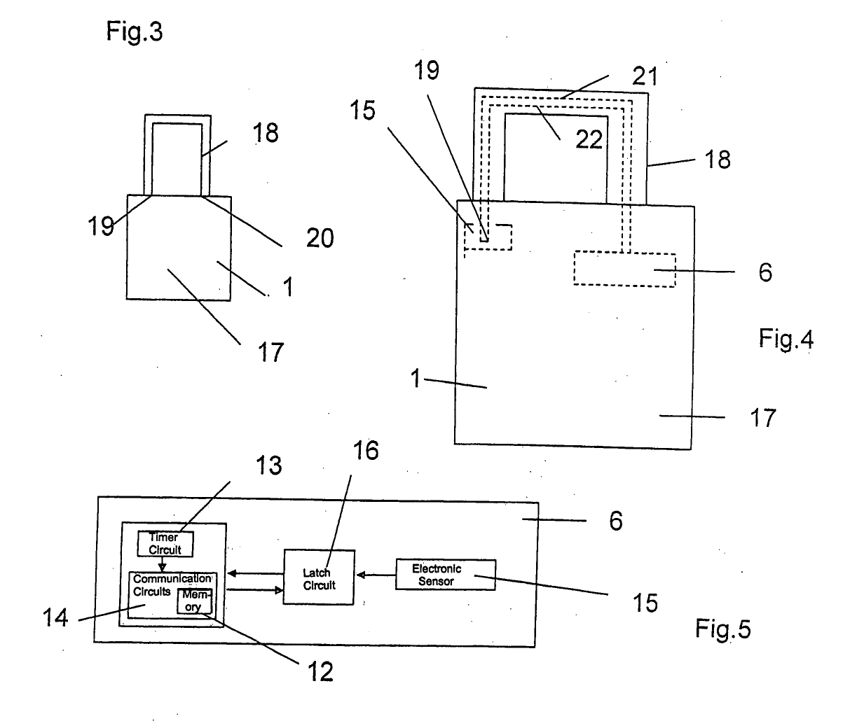

The present invention relates to a seal 1, shown in FIGS. 3, 4, and 5, for sealing goods into goods containers such as freight containers, freight cars, trucks, and the like. The seal 1 is arranged to interact with a door or other hatch that can be opened, in order to seal it against unauthorized opening, which seal is activated when the goods container is loaded and is broken when the goods in the goods container are to be unloaded.

In accordance with one aspect of the invention, the seal 1 includes a transponder 6 for communication with a communicator 2 for the reading of information stored in the transponder. The communication takes place via a communication link, as has been described above in association with FIG. 1.

The transponder is placed into an active mode during the sealing operation.

Furthermore, when the seal 1 is opened the transponder 6 stores time information in a memory 12 (see FIG. 5) that belongs to the transponder. The time information can be read by means of the communicator 2.

In accordance with one preferred embodiment, the transponder receives an inquiry signal from a communicator 2 and modulates and reflects the inquiry signal back to the communicator with information stored in the memory 12 of the transponder.

It is appropriate that the communicators should be portable.

In accordance with one preferred embodiment, the seal 1 includes a timer circuit 13 to keep track of time, which timer circuit emits a signal to the memory 12 of the transponder 6 when the seal is opened.

That means that a seal can be sealed when, for example, a door of a goods container is closed, and that it can be determined by means of a communicator at a later occasion, for example when the load has arrived at its final destination, whether the seal has been broken before the load has arrived, together with time information concerning when the seal was broken.

The time information can be a point in time, or it can be a number of timer pulses that are stored in the seal. For example, the seal can include a real-time clock. Alternatively, the timer circuit can count one pulse per second starting at a certain time point, for example. In both cases the time information contained in the memory 12 enables the time at which the seal was broken to be determined.

FIG. 4 shows a transponder 6 in a seal 1, and FIG. 5 shows the electronic circuits 14 necessary for communication with communicators 2, the timer circuit 13, and an electronic sensor 15 that emits a signal when the seal is broken and, where appropriate, when the seal 1 is sealed.

In accordance with one preferred embodiment, the seal 1 includes a latch circuit 16 arranged to be placed into an active mode when the seal 1 is opened, which latch circuit 16 can be reset only by the communicator 2 transmitting a signal to the transponder 6.

The described design ensures that an unauthorized person cannot open the seal and thereafter close it again and reset the seal so that it would not be possible to determine at a later stage that unauthorized opening of the seal had taken place. The time of the unauthorized opening is stored in the memory 12 of the transponder and cannot be reset, unless a communicator 2 transmits a signal to the transponder, which thereby resets the latch circuit 16.

Referring to FIG. 3, seal 1 has a body 17 including the electronics of the transponder 6 and an aerial (not shown), and a shackle 18, or wire, that extends between two points 19, 20 on the body 17. The shackle 18, or wire, is attached at one end 19 to the body 17 in a manner such that it can be detached. It is appropriate that the end 19 of the shackle 18 is attached in a removable manner by a suitable type of snap-in closure. As shown in FIG. 4, the electronic sensor 15 is located at shackle end 19. Electronic sensor 15 can include a switch that is reset when the end 19 is attached or removed, i.e., when the seal is sealed or opened. The sensor 15 is thus arranged to emit a signal to the timer circuit 13 and to the latch circuit 16 when the seal is broken.

The shackle 18, or wire, is formed as a loop or the like, in the same manner as the loop of a conventional seal.

Alternatively, the seal 1 can be integrated into a lock arrangement for a door of a freight container, for example.

The seal 1 is, as has been described, arranged to store the time information concerning when the end 19 is released. It is preferred that the time information is stored even if the shackle or the wire is cut. The shackle can therefore include an electrical conductor that provides a pathway 21 from the transponder 6 to electronic sensor 15 at the end 19, and provides return pathway 22 to the transponder 6. When the electrical conductor is broken, or short-circuited, a signal is emitted to the latch circuit 16 and to the timer circuit 13.

It is preferred that the seal 1 is configured to store two or more time designations at its opening and at its sealing. In that way it is possible subsequently to reconstruct a complete chain of events.

In accordance with a highly preferred embodiment, the seal 1 has a unique identity.

In accordance with another highly preferred embodiment, the seal 1 is arranged to interact with communicators 9-11, each of which has a unique identity. It is preferred in this case that the identity of the communicator in question is stored in the memory of the transponder.

That makes it possible subsequently to determine which communicator has been used in order to seal the seal by resetting the latch circuit of a particular seal.

With the aim of further increasing security and that authorized communicators are used, it is preferred that the seal stores a checksum, and that the communicator compares that checksum with a checksum calculated in the communicator, based on information transferred from the transponder to the communicator. The checksum can be a calculation in accordance with an algorithm using data that can be read from the transponder, including time information. It is only in the case in which the checksums agree that the transponder can be reset. If that is not the case, a suitable alarm signal is transmitted, preferably to a central computer system. The alarm signal can be transmitted over a GSM-link in the communicator.

It is preferred in a transport system that utilizes a security seal in accordance with the present invention that information about the seal that is used is transmitted to a central database 23 that is controlled by a computer 24 (see FIG. 2). At least the identity (ID) of the seal is transmitted. That transmission does not take place directly from the transponder, but in another suitable manner, such as via a personal computer. Furthermore, the time information is preferably transmitted via the communicators 9, 10, 11 to the central database 23.

Furthermore, information about the identity of the communicator is transmitted to the database. That identity can be coupled in the database to geographical location, authorized user, etc. Such a procedure ensures that goods can be followed from the sealing operation until they are unloaded by the seal being broken. It is for that purpose preferred that each communicator 9, 10, 11 is arranged to transmit via a wireless telephone system, such as a GSM system, information to the central database 23.

The present invention thus provides a significantly higher level of security.

A number of embodiments have been described above. However, it is clear that one skilled in the art can design the seal in another manner without deviating from its function. Furthermore, additional information can be stored in the seal, such as the nature of the goods, their destination, etc.

Thus the present invention is not to be regarded as limited to the embodiments specified above, since variations can be made within the scope of the appended claims.

What is claimed is:

1. A seal for sealing goods in a goods container to detect unauthorized opening of the container, which seal is activated when the goods container is loaded and is broken when the goods in the goods container are to be unloaded, wherein the seal comprises: a housing; attachment means for attaching the housing to an access securement means of a goods container; a transponder carried by the housing for communicating with a communicator that receives information stored in a memory in the transponder, wherein the transponder receives an inquiry signal from the communicator and reflects the inquiry signal back to the communicator modulated by information contained in the memory of the transponder, wherein the transponder is placed into an active mode during a container access means sealing operation, wherein when the attachment means is opened time information stored in the transponder memory is read by the communicator.

2. A seal according to claim 1, wherein the transponder includes a timer circuit to keep track of time, which timer circuit transmits to the transponder memory a signal containing time information relating to at least one of a time when the seal is opened and a time when the seal is sealed.

3. A seal according to claim 1, wherein the transponder includes a latch circuit that is placed into an active mode when the seal is opened, which latch circuit can be reset only by the communicator sending a signal to the transponder.

4. A seal according to claim 1, wherein the seal a has a unique identity.

5. A seal according to claim 1, wherein the seal interacts with a plurality of communicators each of which has a unique identity, and wherein the identity of a communicator is stored in the transponder memory.

6. A seal according to claim 1, wherein the seal stores a checksum, and a communicator compares the stored checksum with a checksum calculated in the communicator based on information transmitted from the transponder to the communicator.

7. A seal according to claim 1, wherein the seal has a body including electronics components of the transponder, an aerial, and connector that passes between two points on the seal body, where one end of the connector is releasably attached to the seal body.

8. A seal according to claim 2, wherein the seal stores the time information in the transponder memory when an end of a connector carried by the seal is disconnected.

9. A seal according to claim 2, wherein the transponder memory stores at least two time designations corresponding to times when the seal is opened and when it is sealed.

10. A seal according to claim 7, wherein the connector is a shackle.

11. A seal according to claim 7, wherein the connector is a wire.
